(19) United States
(12) Patent Application Publication
(10) Pub. No.: US 2021/0064370 A1
(43) Pub. Date: Mar. 4, 2021

(54) SYSTEM, MODIFICATION APPARATUS, METHOD, AND PROGRAM

(71) Applicant: NEC CORPORATION, Tokyo (JP)

(72) Inventor: Isamu TERANISHI, Tokyo (JP)

(73) Assignee: NEC CORPORATION, Tokyo (JP)

(21) Appl. No.: 16/644,363

(22) PCT Filed: Sep. 5, 2017
(86) PCT No.: PCT/JP2017/032001

§ 371 Date: Mar. 4, 2020

(51) Int. Cl. G06F 9/30; G06F 9/38; G06F 9/48; G06F 9/50

(52) U.S. Cl. CPC G06F 9/3005; G06F 9/5044; G06F 9/4881; G06F 9/3836

(57) ABSTRACT

A system includes a modification apparatus and an execution apparatus. The modification apparatus modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s). The execution apparatus executes the modified program in an execution environment protected at a hardware level.

### CROSS REFERENCE TO RELATED APPLICATIONS

This application is a National Stage of International Application No. PCT/JP2017/032001 filed Sep. 5, 2017.

### FIELD

The present invention relates to a system, a modification apparatus, a method, and a program. In particular, it relates to a system, a modification apparatus, a method, and a program that execute a program.

### BACKGROUND

Data encryption is used as means for ensuring security of important data such as personal information, authentication information, or confidential information needing high confidentiality. However, when some data processing such as statistic calculation, authentication processing, or searching is performed on such important data, the encryption needs to be decrypted once. Thus, if an attacker conducts an attack the moment the data processing is performed (the moment the encryption is decrypted), the important data could be leaked.

In recent years, a plurality of semiconductor vendors have proposed techniques for protecting programs and data at a hardware level (these techniques will hereinafter be referred to as hardware-based protection techniques) (see NPLs 1 and 2). The techniques (devices) disclosed in NPLs 1 and 2 create secure execution environments in which access cannot be made by external software, etc. and protect software codes or data.

In addition, NPL 3 discloses memories referred to as “Oblivious RAMs”. According to this literature, it is guaranteed that all memories are accessed only once in a certain period, and the localities of reference of the memories can be hidden by changing address association per certain period.

NPL 1: Intel, “Intel Software Guard Extensions (intel SGX)”, Jun. 15, 2017, [online], [searched on Jun. 15, 2017], Internet <URL:https://software.intel.com/en-us/sgx>

NPL 2: ARM, “A SYSTEM-WIDE APPROACH TO SECURITE”, Jun. 15, 2017, [online], [searched on Jun. 15, 2017], Internet <URL:https://www.arm.com/products/security-on-arm/trustzone>

NPL 3: Oded Goldreich and Rafail Ostrovsky, “Software protection and simulation on Oblivious RAMs”, J. ACM, 43 (3): 431-473, 1996

### SUMMARY

The disclosure of each of the above NPLs is incorporated herein by reference thereto. The following analysis has been made by the present inventors.

The above hardware-based protection techniques are techniques for preventing an attacker from affecting a program by isolating the program or data to an (isolated) area created at a hardware level (this area will hereinafter be referred to as a hardware-based isolated area). In the hardware-based protection techniques, areas to which OSs (Operating Systems) and applications can normally access are separated from an area (a hardware-based isolated area) to which the OSs, etc. cannot access without a special procedure, and the program is executed in the hardware-based isolated area.

A certain level of protection can be achieved by processing the above important data in such a hardware-based isolated (the risk of information leakage can be reduced to some extent). However, these hardware-based protection techniques have problems, too. Specifically, even if important data is isolated to a hardware-based isolated area, these techniques are vulnerable to a scheme referred to as “a side channel attack”. Namely, even if the hardware-based protection techniques (devices on which these techniques have been implemented) disclosed in NPLs 1, 2, etc. are used, there is still a possibility that important data could be leaked to attackers. Thus, it is desirable that the protection be further enhanced.

The side channel attack is an offensive scheme for predicting important data from the time (processing time) or power consumption (resource consumption) that hardware uses during data processing or electromagnetic waves, operating noise, etc. that hardware generates. As the measures against this attack, for example, the technique (calculation by using an Oblivious RAM) disclosed in NPL 3 is referred to as “leakage resistance calculation”. This technique can be considered as a method that can ensure security even if partial information of secret information is leaked by a side channel attack.

In addition, one possible method for protecting important data is to combine an encryption technique with the hardware-based protection technique disclosed in NPL 1 or 2 and the technique (calculation by using an Oblivious RAM) disclosed in NPL 3. For example, it is possible to prevent leakage of important data by encrypting the important data in advance while performing data processing on the important data with hardware that allows a side channel attack. Namely, by using leakage resistance calculation or encryption processing and by processing important data in a hardware-based isolated area, in principle, it is possible to perform the calculation while concealing the important data. However, normally, since the execution efficiency of leakage resistance calculation or the like is very poor, the above method is not a realistic method.

It is an object of the present invention to provide a system, a modification apparatus, a method, and a program that robustly prevent data leakage.

According to a first aspect of the present invention, there is provided a system including: a modification apparatus that modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s); and an execution apparatus that executes the modified program in an execution environment protected at a hardware level.

According to a second aspect of the present invention, there is provided a modification apparatus that modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s).

According to a third aspect of the present invention, there is provided a method, including: modifying a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s); and executing the modified program in an execution environment protected at a hardware level.

According to a fourth aspect of the present invention, there is provided a program, causing a computer to execute processing for: receiving a program including a conditional branching statement(s); and modifying the program including the conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s). This program can be stored in a computer-readable storage medium. The storage medium may be a non-transient storage medium such as a semiconductor memory, a hard disk, a magnetic storage medium, or an optical storage medium. The present invention may be embodied as a computer program product.

According to the individual aspects of the present invention, there are provided a system, a modification apparatus, a method, and a program that contribute to robustly preventing data leakage.

### BRIEF DESCRIPTION OF DRAWINGS

FIG. 1 illustrates an outline according to an exemplary embodiment.

FIG. 2 illustrates an example of a program execution system according to a first exemplary embodiment.

FIG. 3 illustrates an example of a hardware configuration of a program modification apparatus according to the first exemplary embodiment.

FIG. 4A illustrates an example of a hardware configuration of a program execution apparatus according to the first exemplary embodiment.

FIG. 4B illustrates an example of a hardware configuration of a program execution apparatus according to the first exemplary embodiment.

FIG. 5 illustrates an example of a processing configuration of the program modification apparatus according to the first exemplary embodiment.

FIG. 6 illustrates an example of a program inputted to the program modification apparatus.

FIG. 7 is a flowchart illustrating an example of a program modification operation of a program modification part.

FIG. 8 illustrates an operation of the program modification part.

FIG. 9 illustrates an operation of the program modification part.

FIG. 10 illustrates an example of a processing configuration of the program execution apparatus according to the first exemplary embodiment.

FIG. 11 is a flowchart illustrating an example of an operation of the program execution apparatus according to the first exemplary embodiment.

### PREFERRED MODES

First, an outline of an exemplary embodiment will be described. Reference characters in the following outline denote various elements for the sake of convenience and are used as examples to facilitate understanding of the present invention. Namely, the description of the outline is not intended to indicate any limitations. An individual connection line between blocks in an individual drawing signifies both one-way and two-way directions. An arrow schematically illustrates a principal signal (data) flow and does not exclude bidirectionality

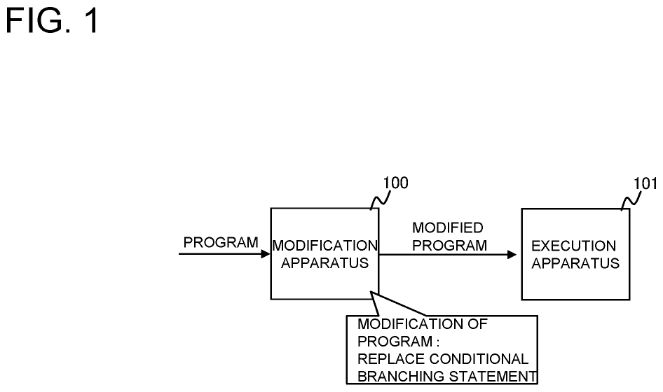

A system according to an exemplary embodiment includes a modification apparatus 100 and an execution apparatus 101 (see FIG. 1). The modification apparatus 100 modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s). The execution apparatus 101 executes the modified program in an execution environment protected at a hardware level.

As described above, while the hardware-based protection technique is advantageous to a certain degree in protection from attacks by attackers, important data cannot be sufficiently protected when a side channel attack is conducted. Thus, the system according to the exemplary embodiment modifies a program, assuming that the program is executed in an execution environment protected at a hardware level. The modification apparatus 100 replaces a conditional branching statement(s) included in the program by processing for executing first processing (an always-executed code(s) to be described below) approximately the same as the execution processing in the branching statement(s) and reflecting, if a determination result(s) of a conditional expression(s) included in the conditional branching statement(s) indicates execution of the execution processing, an execution result(s) of the first processing to a variable(s) used in the original program.

As a result of the above replacement, whether the determination result(s) of the conditional expression(s) in the conditional branching statement(s) included in the unmodified program is true or false, the first processing (the always-executed code(s)) having approximately the same length(s) as that of the execution processing is always executed.

In this way, the execution time of the modified program does not depend on the content(s) of the condition(s) in the conditional branching statement(s). In addition, if the determination result(s) of the conditional expression(s) in the conditional branching statement(s) indicates “execution of the execution processing”, the execution result(s) of the first processing needs to be reflected. However, since the reflection processing is processing for assigning a value(s) to a variable(s), which is very simple processing, the processing time of the reflection processing is very short. Thus, even if an attacker conducts a side channel attack, the attacker cannot obtain useful information only from the information about whether the reflection processing has been performed.

By executing a program modified as described above in an execution environment protected at a hardware level, data leakage can be protected more robustly.

Hereinafter, a specific exemplary embodiment will be described in more detail with reference to drawings. Like reference characters refer to like elements throughout the exemplary embodiment, and description thereof will be omitted.

### First Exemplary Embodiment

A first exemplary embodiment will be described in more detail with reference to drawings.

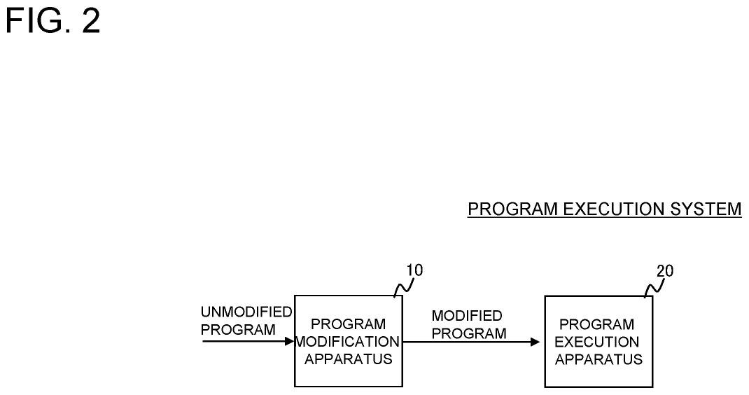

FIG. 2 illustrates an example of a program execution system according to the first exemplary embodiment. As illustrated in FIG. 2, this program execution system includes a program modification apparatus 10 and a program execution apparatus 20.

The program modification apparatus 10 receives a program and modifies the program. The program modification apparatus 10 supplies the modified program to the program execution apparatus 20. The program modification apparatus 10 receives an unmodified program that handles important data as an input, modifies the unmodified program into a safe program (a modified program) that does not cause data leakage, and outputs the safe program. More specifically, the program modification apparatus 10 modifies a program including a conditional branching statement(s) (for example, an IF statement) such that, after first processing (an always-executed code(s) to be described below) corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s).

The program execution apparatus 20 receives the modified program and executes the modified program by using the important data. More specifically, the program execution apparatus 20 executes the program obtained after the modification by the program modification apparatus 10 in an execution environment protected at a hardware level as disclosed in NPL 1 or 2.

In the following description, the program received by the program modification apparatus 10 will be referred to as “an unmodified program”. In addition, the program outputted by the program modification apparatus 10 will be referred to as “a modified program”.

While the individual program handled in the first exemplary embodiment is a program written in C language, a program written in another program language may of course be used. In addition, while an uncompiled program will be described as a modification target in the first exemplary embodiment, compiled data (code) may be used as a modification target.

### Hardware Configuration

A hardware configuration of an individual one of the apparatuses constituting the program execution system according to the first exemplary embodiment will be described.

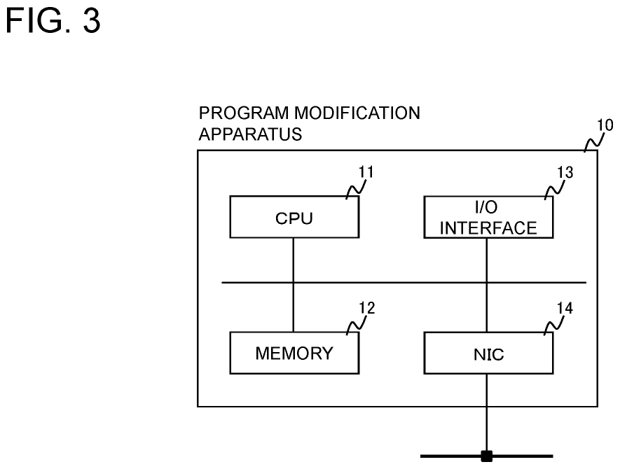

FIG. 3 illustrates an example of a hardware configuration of the program modification apparatus 10 according to the first exemplary embodiment. The program modification apparatus 10 can be realized by a so-called computer (an information processing apparatus) and has a configuration illustrated as an example in FIG. 3. For example, the program modification apparatus 10 includes a CPU (Central Processing Unit) 11, a memory 12, an input-output (I/O) interface 13, and a NIC (Network Interface Card) 14, which is a communication interface, etc., which are connected to one another via an internal bus.

The hardware configuration of the program modification apparatus 10 is not limited to the configuration illustrated in FIG. 3.

The program modification apparatus 10 may include hardware not illustrated or may be configured without, for example, the I/O interface 13, as appropriate. For example, when information is inputted to or outputted from the program modification apparatus 10 via a terminal connected to a network, there are cases in which the I/O interface 13 is not necessary. In addition, the number of CPUs or the like included in the program modification apparatus 10 is not limited to the example illustrated in FIG. 3. For example, a plurality of CPUs may be included in the program modification apparatus 10.

The memory 12 is a RAM (Random Access Memory), a ROM (Read Only Memory), or an auxiliary storage device (a hard disk or the like).

The I/O interface 13 is an interface for a display apparatus or an input apparatus not illustrated. The display apparatus is, for example, a liquid crystal display or the like. The input apparatus is, for example, an apparatus such as a keyboard or a mouse that receives user operations or an apparatus that receives information from an external storage device such as a USB (Universal Serial Bus) memory. The user uses a keyboard, a mouse, or the like, to input necessary information to the program modification apparatus 10.

Functions of the program modification apparatus 10 are realized by processing modules, which will be described below. These processing modules are realized by causing the CPU 11 to execute a program stored in the memory 12, for example. The program may be updated by downloading a program via a network or by using a storage medium in which a program is stored. In addition, the processing modules may be realized by a semiconductor chip. Namely, the functions performed by the processing modules can be realized by some hardware and/or software.

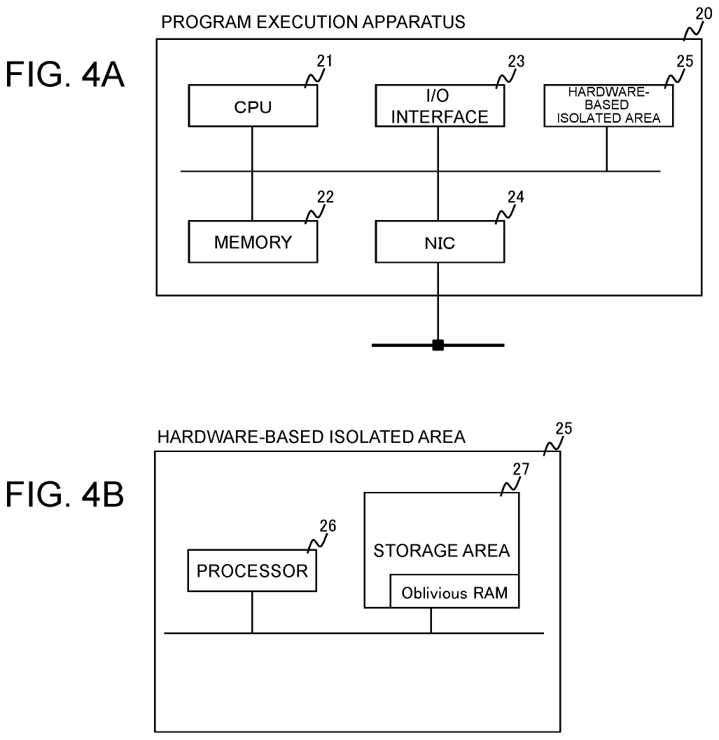

FIGS. 4A and B illustrate an example of a hardware configuration of the program execution apparatus 20 according to the first exemplary embodiment. As illustrated in FIG. 4A, the program execution apparatus 20 includes a hardware-based isolated area 25 in addition to the configuration illustrated in FIG. 3.

The hardware-based isolated area 25 is an area (a device) that realizes the hardware-based protection technique disclosed in NPL 1 or 2. Namely, the program execution apparatus 20 may include the device disclosed in NPL 1 or 2.

As illustrated in FIG. 4B, the hardware-based isolated area 25 includes a processor 26 and a storage area 27. The processor 26 is a calculation part (calculation means) that can execute a program. The storage area 27 is a storage part (storage means) that temporarily holds data and is a memory such as a DRAM or a register, for example. In addition, the storage area 27 includes an “Oblivious RAM” disclosed in NPL 3.

Data (important data; confidential data) needed for execution of a program is stored in the memory 22, which is an HDD (Hard Disk Drive) or the like. The important data stored in the HDD or the like is previously encrypted and stored in the memory 22. Any encryption method may be used to encrypt the important data. For example, an encryption algorithm such as AES (Advanced Encryption Standard) may be used.

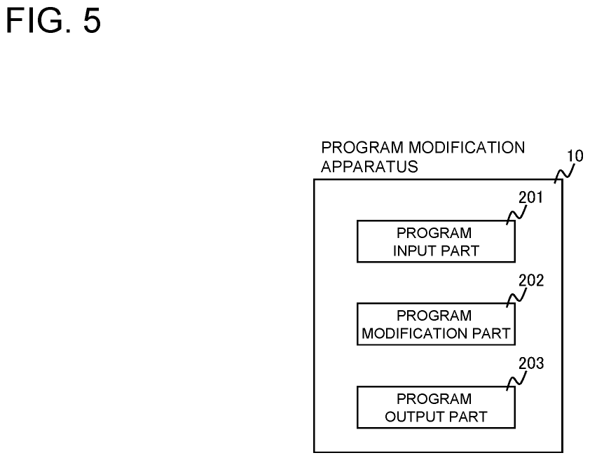

FIG. 5 illustrates an example of a processing configuration of the program modification apparatus 10 according to the first exemplary embodiment. As illustrated in FIG. 5, the program modification apparatus 10 includes a program input part 201, a program modification part 202, and a program output part 203.

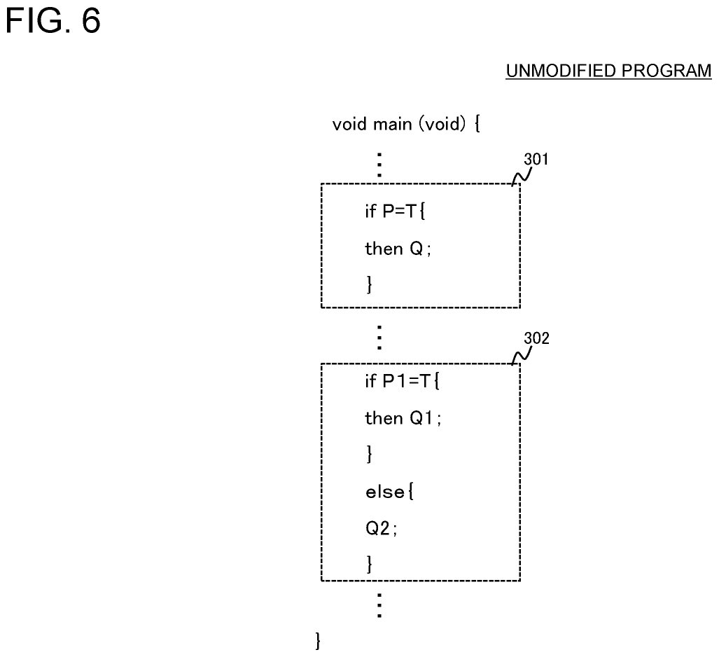

The program input part 201 is means for receiving unmodified programs. For example, the program input part 201 receives a program as illustrated in FIG. 6. The program input part 201 gives the acquired program (the unmodified program) to the program modification part 202.

The program modification part 202 is means for modifying programs. More specifically, the program modification part 202 modifies a program by replacing a conditional branching statement included in this unmodified program by processing including first processing (an always-executed code to be described below), processing for performing determination based on a conditional expression in the conditional branching statement, and second processing (a variable update code to be described below). The second processing is processing for assigning variables obtained as a result of the execution of the first processing to variables used in execution processing in the conditional branching statement when a determination result based on the conditional expression indicates execution of the execution processing in the conditional branching statement.

To perform the above program modification, the program modification part 202 searches the acquired program for a conditional branching statement, generates a replacement code (a code including the first processing, the determination processing, and the second processing) for replacing the conditional branching statement, and modifies the program. Examples of the conditional branching statement include an IF statement, an IF-ELSE statement, and a SWITCH statement.

In the unmodified program illustrated in FIG. 6, the program modification part 202 retrieves an IF statement 301 and an IF-ELSE statement 302, replaces these conditional branching statements by a replacement code (a replacement program), and modifies the program.

An IF statement is constituted by “a conditional expression (a conditional statement)” and “execution processing (an execution content)”. While the “execution processing” is executed if the “condition” is T (True), the “execution processing” is not executed if the “condition” is F (False). In the example in FIG. 6, while execution processing (function, code) Q is executed if a condition P is “true”, the execution processing Q is not executed if the condition P is “false”.

In addition, an IF-ELSE statement is constituted by “a conditional expression”, “execution processing”, and “negative execution processing”. While the “execution processing” is executed if the “condition” is true, the “negative execution processing” is executed otherwise.

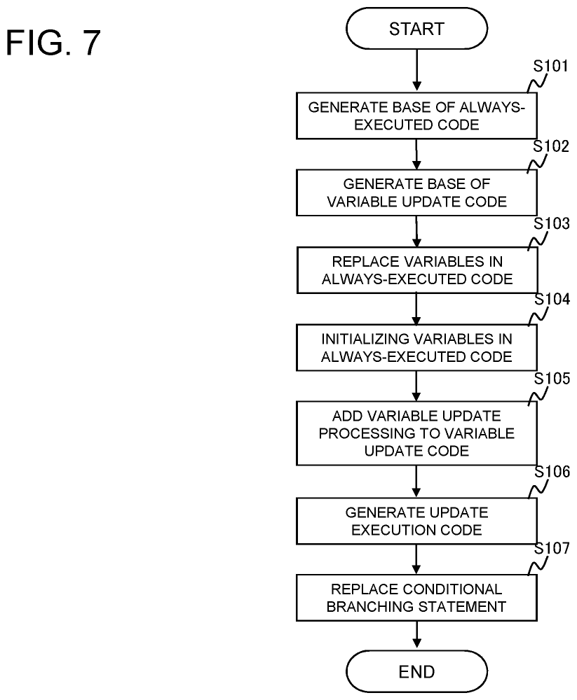

FIG. 7 is a flowchart illustrating an example of a program modification operation of the program modification part 202.

In step S101, the program modification part 202 duplicates “execution processing” in a conditional branching statement and generates a base of “an always-executed code”.

In step S102, the program modification part 202 generates a null character string as a base of “a variable update code”.

In step S103, the program modification part 202 replaces individual variables in the always-executed code by other variables. In this step, the program modification part 202 selects temporary variables that are not used (that do not appear) in the unmodified program and replaces the individual variables in the always-executed code by the selected variables. For example, if a variable included in the always-executed code is X and another replacement variable (a temporary variable) is X1, the variable X included in the always-executed code is replaced by the variable X1.

In step S104, the program modification part 202 adds processing (X1=X) for initializing the replacement variable (the variable X1 in the above example) by using the replaced variable (the variable X in the above example) at the beginning of the always-executed code.

In step S105, the program modification part 202 writes processing (X=X1) for updating the replaced variable (the variable X in the above example) in the always-executed code to the replacement variable (X1 in the above example) in a variable update code.

In this way, the program modification part 202 duplicates execution processing in a conditional branching statement, replaces a first variable (the variable X in the above example) included in the duplicated execution processing by a second variable (the variable X1 in the above example) that is not used in the program, and initializes the second variable by using the first variable, to generate an always-executed code. In addition, the program modification part 202 generates a variable update code as processing for assigning the value of the second variable to the first variable.

In step S106, the program modification part 202 generates an “update execution code” indicating that the “variable update code” is executed by using “leakage resistance calculation” if the condition in the conditional branching statement is “true”. Namely, the program modification part 202 generates an update execution code including the determination processing using the conditional expression included in the conditional branching statement and the variable update processing.

In step S107, the program modification part 202 replaces (modifies) the conditional branching statement by the processing for executing the “update execution code” after executing the “always-executed code”.

Next, the above processing will be specifically described with reference to drawings.

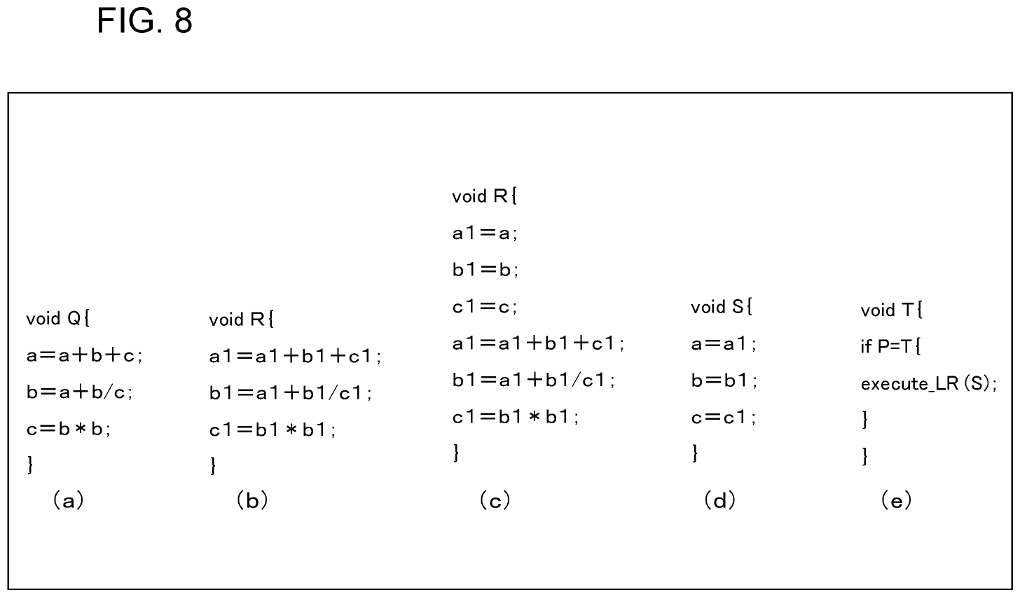

For example, if the execution processing Q in the IF statement 301 indicates the content illustrated in FIG. 6 is that illustrated in FIG. 8(a), the program modification part 202 duplicates the execution processing Q and replaces variables a to c used in the execution processing Q by variables a1 to c1, respectively. In this way, the program modification part 202 generates the base of an always-executed code R (see FIG. 8(b)).

Next, the temporary variables a1 to c1 are initialized by using the variables a to c used in the execution processing Q and inserted at the beginning of the always-executed code R (see FIG. 8(c)).

Next, the program modification part 202 writes processing for assigning the result (the variables a1 to c1) obtained by processing of the always-executed code R to the variables a to c used in the execution processing Q to the base of a variable update code S (see FIG. 8(d)).

Next, the program modification part 202 generates an update execution code T including the content that the variable update code S is executed by using leakage resistance calculation if the condition P in the conditional branching statement is “true” (see FIG. 8(e)). Namely, the program modification part 202 modifies the program such that the variable update code S is executed by using leakage resistance calculation. In FIG. 8(e), “execute_LR(S)” indicates that the variable update code S is executed by using leakage resistance calculation.

Next, the program modification part 202 replaces the IF statement 301 illustrated in FIG. 6 by the content that the update execution code T is executed after the always-executed code R is executed.

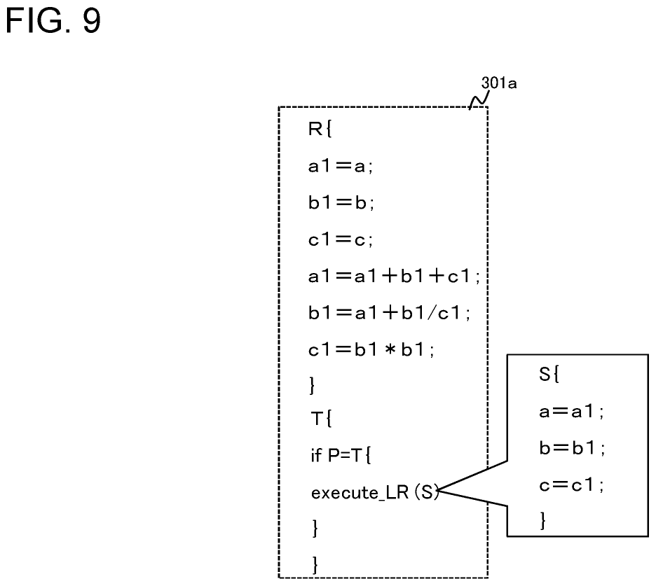

As a result, the IF statement 301 illustrated in FIG. 6 is replaced by a replacement text 301a illustrated in FIG. 9. As illustrated in FIG. 9, it is seen that, while the always-executed code R having approximately the same content as that of the execution processing Q in the conditional branching statement is always executed, the result is reflected on the variables (the variable update code S is executed) only when the condition P is “true”. Namely, even when the IF statement 301 is replaced by the replacement text 301a, the execution result is not changed.

Since the operation of the assignment to the variables a to c in the execution processing Q in the conditional branching statement is performed only when the condition P is “true”, the execution result of the always-executed code R does not affect the other segments of the program.

The program modification part 202 also replaces a conditional branching statement such as an IF-ELSE statement or a SWITCH statement by a replacement code, as is the case with an IF statement.

For example, in the example illustrated in FIG. 6, the program modification part 202 generates an always-executed code R1 and a variable update code S1 corresponding to an execution processing Q1 included in the IF-ELSE statement 302 in accordance with a method similar to the above method. Likewise, the program modification part 202 generates an always-executed code R2 and a variable update code S2 corresponding to an execution processing Q2 included in an IF-ELSE statement 302. Next, the program modification part 202 generates an update execution code T including the content that the program modification part 202 executes the variable update code S1 by using leakage resistance calculation if a condition P1 is “true” and that the program modification part 202 executes the variable update code S2 by using leakage resistance calculation if the condition P2 is “false”.

Next, the program modification part 202 replaces the IF-ELSE statement 302 by the content that the update execution code T is executed after the always-executed codes R1 and R2 are executed.

A SWITCH statement is only a statement that is obtained by expanding the conditional branching of the above IF statement and IF-ELSE statement to three or more branches. Thus, since generation of a replacement code of a SWITCH statement is apparent to those skilled in the art, description thereof will be omitted.

Referring back to FIG. 5, the program output part 203 outputs the program obtained by the modification by the program modification part 202 to the program execution apparatus 20.

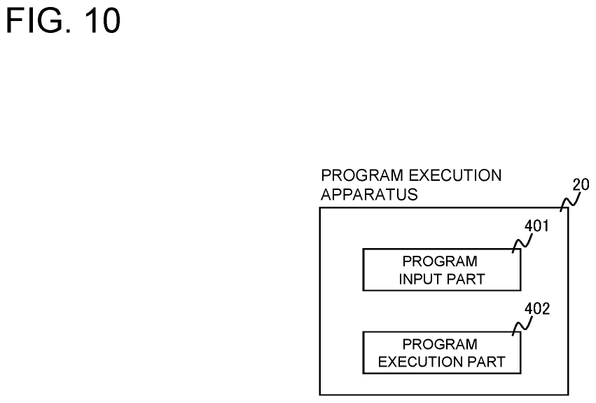

FIG. 10 illustrates an example of a processing configuration of the program execution apparatus 20 according to the first exemplary embodiment. As illustrated in FIG. 10, the program execution apparatus 20 includes a program input part 401 and a program execution part 402.

The program input part 401 is means for receiving a modified program. The program input part 401 gives the acquired program (the modified program) to the program execution part 402.

The program execution part 402 executes the modified program in the hardware-based isolated area 25. More specifically, the program execution part 402 loads the modified program to the storage area 27 in the hardware-based isolated area 25.

In addition, the program execution part 402 loads encrypted important data stored in the memory 22 (a secondary storage area) to the storage area 27 in the hardware-based isolated area 25. The program execution part 402 generates an execution code, for example, by compiling the modified program as needed and loads the execution code to the hardware-based isolated area 25.

Next, the program execution part 402 instructs the processor 26 to decrypt the encrypted important data and execute the modified program. Upon receiving this instruction, the processor 26 decrypts the encrypted data loaded to the storage area 27 and executes the modified program. As needed, the program execution part 402 also loads a program for decrypting the important data to the hardware-based isolated area 25.

The processor 26 executes the modified program. In this operation, if the modified program indicates that the code is executed by using “leakage resistance calculation” (if execute LR is specified in the above example), the processor 26 executes the specified code by using “leakage resistance calculation”. Specifically, the processor 26 executes the specified code on the above “Oblivious RAM”.

In the above example, since the program indicates that the variable update code S is executed by using leakage resistance calculation, the assignment processing written in the code is executed on the “Oblivious RAM”. Since the leakage resistance calculation is executed by using “Oblivious RAM” or the like, even when access to (reading/writing of) a memory is being monitored, leakage of the important data can be prevented. The leakage resistance calculation on the “Oblivious RAM” has a problem in that the execution speed is low. However, the leakage resistance calculation executed by the program execution apparatus 20 is directed to a code having a small program size such as the variable update code S, the decrease of the execution speed is limited.

The CPU 21 executes the processing relating to, for example, instructing the program execution part 402 to execute the modified program by using the hardware-based isolated area 25.

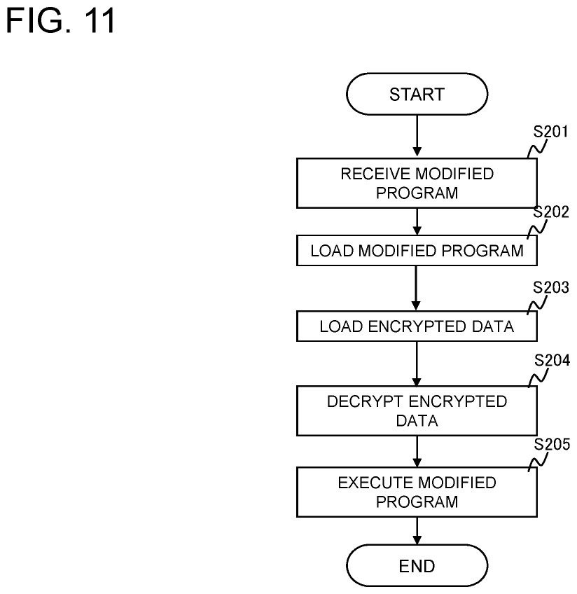

FIG. 11 is a flowchart illustrating an operation of the program execution apparatus 20.

In step S201, the program input part 401 receives a modified program.

In step S202, the program execution part 402 loads the modified program to the hardware-based isolated area 25.

In step S203, the program execution part 402 loads encrypted data to the hardware-based isolated area 25.

In step S204, the processor 26 decrypts the encrypted data.

In step S205, the processor 26 executes the modified program. In this step, the variable update code S is executed on an “Oblivious RAM”.

According to the first exemplary embodiment, there is provided a program execution system that prevents leakage of important data even when an attacker measures the execution time of a program. Specifically, since the program modification apparatus 10 modifies the program, the above information leakage is prevented.

A program normally includes conditional branching statements such as IF statements. An IF statement included in a program is constituted by a conditional expression and an execution processing Q, and the execution processing Q is executed when a condition P is “true”.

The execution processing Q is not executed, otherwise. Namely, the execution of the execution processing Q is determined depending on whether the condition P is true or false, and the processing time differs depending on whether the execution processing Q is executed. Thus, particularly when true or false depends on the content (value) of the important data in the conditional expression, if an attacker measures the execution time of the program, partial information of the important data could be leaked.

According to the first exemplary embodiment, in view of the above circumstances, a conditional branching statement in a program is extracted and modified. The program modification apparatus 10 extracts a conditional branching statement from an unmodified program and always executes the always-executed code R having approximately the same length as that of the execution processing Q, whether the determination result of the conditional expression in the conditional branching statement is true or false. In this way, the execution time of the modified program does not depend on the content of the condition P.

In addition, the always-executed code R is a program approximately the same as the execution processing Q, and the operation of the assignment to the values of the variables in the execution processing Q is limited so that the execution result of the always-executed code R does not affect the other segments of the program. If the condition P is “true”, the assignment operation (the variable update code S) is executed. As described above, instead of executing a conditional branching statement from an unmodified program, the always-executed code R is always executed, and the variable update code S is executed only when the condition P is “true”. As a result, a side channel attack performed by measuring the above time can be avoided. This is because, unlike an unmodified program, since the program size of variable update code S executed depending on true or false of the condition P is very small, even if an attacker measures the execution time of the program, the attacker cannot obtain much information.

The variable update code S could involve many assignment operations. When the assignment operations are performed, since reading and writing of a memory occur, an attacker could conduct a side channel attack by monitoring the reading and writing of the memory. To protect a program from the side channel attack, according to the first exemplary embodiment, the variable update code S is executed by using “leakage resistance calculation”.

The content of the variable update code S is not complex but is a very simple content, which is a variable assignment operation. Thus, even if a technique, such as code execution on an “Oblivious RAM”, which causes a very low execution speed, is applied to the variable update code S, the program execution apparatus 20 affects the program execution speed very little. When the number of assignment operations included in the variable update code S is very small, it is apparent that the variable update code S does not need to be executed by using “leakage resistance calculation”.

The program execution system according to the first exemplary embodiment is constituted by the following three elements.

The first element is that the whole program is executed in a hardware-based isolated area and is protected based on a “hardware-based protection technique”.

The second element is that, to protect important data from a side channel attack based on time measurement, a conditional branching statement in a program is modified and that the conditional branching statement is replaced by always-executed processing (the always-executed code R) and assignment operation processing (the variable update code S).

The third element is that, to protect important data from a side channel attack based on memory monitoring, execution relating to the variable update code S of the replacement code that has replaced the conditional branching statement is calculated on an “Oblivious RAM” (the variable update code S is executed by using leakage resistance calculation).

In the disclosure of the present application, it is important that the measures against a side channel attack based on time measurement, and a side channel attack based on memory monitoring are complementary. Namely, as the measures against a side channel attack based on time measurement, since a conditional branching statement is replaced by a very simple operation, which is an assignment operation (execution of the variable update code S), even if a technique, such as calculation on an “Oblivious RAM”, which causes a very low execution speed, is applied to the variable update code S as the protection against the side channel attack based on memory monitoring (leakage resistance calculation), the execution speed is affected little.

If different means is employed as protection means against a side channel attack based on time measurement, the execution speed is affected more. For example, a case in which the most fundamental measures against a side channel attack based on time measurement is employed will be considered.

### Measures:

When the program execution time is short, the execution time is consumed by executing unnecessary calculation, to maintain a constant execution time.

If the above measures are employed, the execution efficiency is significantly deteriorated. This is because, if this method is employed, a technique (leakage resistance calculation), such as calculation on an “Oblivious RAM”, which causes poor execution efficiency, needs to be applied to the whole program, to protect against a side channel attack based on memory monitoring. Namely, while the leakage resistance calculation can protect important data even when a side channel attack is conducted, the above method is not realistic since the execution speed is low. In contrast, the program execution system according to the disclosure of the present application is a method that can protect important data even when a side channel attack is conducted and that can achieve a high execution speed.

The configuration (FIG. 2) of the program execution system described in the above exemplary embodiment is illustrated only as an example and is not intended to limit the configuration of the system. For example, the functions of the program modification apparatus 10 and the program execution apparatus 20 may be executed by a single computer (an information processing apparatus).

In addition, in the above exemplary embodiment, when the variable update code S is executed by using “leakage resistance calculation”, the corresponding code is executed on the “Oblivious RAM”. However, the variable update code S may be executed by using another “leakage resistance calculation” method. Namely, any method for executing the variable update code S may be used, as long as security can be ensured even when partial information of secret information is leaked.

In addition, in a plurality of flowcharts used in the above description, a plurality of steps (processes) are described in order. However, the execution order of the steps in an individual flowchart executed according to the individual exemplary embodiment is not limited to the corresponding order described above. In the above exemplary embodiment, the order of the steps in an individual flowchart illustrated may be changed as long as the change does not cause a problem with the corresponding content. For example, the individual steps (processes) may be performed in parallel.

The above exemplary embodiments can partially or entirely be described but not limited to as the following notes.

### [Note 1]

A system, including:
a modification apparatus that modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s); and
an execution apparatus that executes the modified program in an execution environment protected at a hardware level.

### [Note 2]

The system preferably according to note 1; wherein the modification apparatus replaces the conditional branching statement(s) included in the program by processing including the first processing, processing for performing determination based on the conditional expression(s) in the conditional branching statement(s), and second processing for changing when a determination result(s) based on the conditional expression(s) indicates execution of the execution processing of the conditional branching statement(s), a value(s) of a variable(s) obtained as a result of the execution of the first processing to a variable(s) used in the execution processing in the conditional branching statement.

### [Note 3]

The system preferably according to note 2; wherein the modification apparatus modifies the program such that the second processing is executed by using leakage resistance calculation.

### [Note 4]

The system preferably according to note 3; wherein the execution apparatus executes the second processing on an Oblivious RAM (Random Access Memory).

### [Note 5]

The system preferably according to any one of notes 2 to 4; wherein the execution apparatus includes a storage area in which an encrypted variable(s) is stored and executes the modified program after decrypting the encrypted variable(s) in the execution environment protected on the hardware level.

### [Note 6]

The system preferably according to any one of notes 2 to 5; wherein the modification apparatus generates the first processing by duplicating the execution processing in the conditional branching statement(s), replacing a first variable(s) included in the duplicated execution processing by a second variable(s) not used in the program, and initializing the second variable(s) by using the first variable(s).

### [Note 7]

The system preferably according to note 6; wherein the second processing is processing for assigning a value(s) of the second variable(s) to the first variable(s).

### [Note 8]

A modification apparatus that modifies a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s).

### [Note 9]

A method, comprising:
modifying a program including a conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s); and
executing the modified program in an execution environment protected at a hardware level.

### [Note 10]

A program, causing a computer to execute processing for:
receiving a program including a conditional branching statement(s); and modifying the program including the conditional branching statement(s) such that, after first processing corresponding to execution processing in the conditional branching statement(s) is executed, whether to reflect a result(s) of the first processing on a variable(s) used in the program as a processing result(s) of the execution processing is determined based on a conditional expression(s) in the conditional branching statement(s).

### [Note 11]

A system, including a modification apparatus that modifies and outputs an inputted program and an execution apparatus that executes the modified program;
wherein the modification apparatus executes, regarding an individual conditional branch in the inputted program, a program segment performed as a result of the conditional branch always in the modified program;
wherein, only when determination of the condition branch indicates jumping to the program segment, the modification apparatus determines an execution result of the program segment;
wherein the execution apparatus receives the modified program as an input and executes the modified program in an execution environment protected at a hardware level;
wherein secret data necessary to execute the modified program is encrypted and stored;
wherein the secret data is decrypted in the execution environment protected at the hardware level when the modified program is executed; and
wherein the conditional branch in the modified program is executed by using leakage resistance calculation.

### [Note 12]

The system according to note 11; wherein executing the conditional branch in the modified program by using leakage resistance calculation signifies executing the conditional branch on an Oblivious RAM. The modes in notes 8 to 10 can be expanded in the same way as the mode in note 1 is expanded to the modes in notes 2 to 7.

The disclosure of each of the above PTLs, etc. is incorporated herein by reference thereto. Variations and adjustments of the exemplary embodiments and examples are possible within the scope of the overall disclosure (including the claims) of the present invention and based on the basic technical concept of the present invention.

Various combinations and selections of various disclosed elements (including the elements in each of the claims, exemplary embodiments, examples, drawings, etc.) are possible within the scope of the overall disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10 program modification apparatus
11, 21 CPU
12, 22 memory
13, 23 input-output interface
14, 24 NIC
20 program execution apparatus
25 hardware-based isolated area
26 processor
27 storage area
100 modification apparatus
101 execution apparatus
201, 401 program input part
202 program modification part
203 program output part
301 IF statement
301a replacement text
302 IF-ELSE statement
402 program execution part

1. A system, comprising:
a modification apparatus that modifies an unmodified program including a conditional branching statement(s) to a modified program that, based on conditional expression(s) in the conditional branching statement(s), determines whether or not to reflect a result(s) of first processing corresponding to execution processing in the conditional branching statement(s) as a processing result(s) of the execution processing; and
an execution apparatus that executes the modified program in an execution environment protected at a hardware level.

2. The system according to claim 1; wherein the modification apparatus replaces the conditional branching statement(s) included in the unmodified program by processing including:
the first processing,
processing for performing determination based on the conditional expression(s) in the conditional branching statement(s), and
second processing for changing when a determination result(s) based on the conditional expression(s) indicates execution of the execution processing of the conditional branching statement(s), a value(s) of a variable(s) obtained as a result of the execution of the first processing to a variable(s) used in the execution processing in the conditional branching statement.

3. The system according to claim 2; wherein the modification apparatus modifies the unmodified program such that the second processing is executed by using leakage resistance calculation.

4. The system according to claim 3; wherein the execution apparatus executes the second processing on an Oblivious RAM (Random Access Memory).

5. The system according to claim 2;
wherein the execution apparatus includes a storage area in which an encrypted variable(s) is stored and executes the modified program after decrypting the encrypted variable(s) in the execution environment protected on the hardware level.

6. The system according to claim 2; wherein the modification apparatus generates the first processing by duplicating the execution processing in the conditional branching statement(s), replacing a first variable(s) included in the duplicated execution processing by a second variable(s) not used in the unmodified program, and initializing the second variable(s) by using the first variable(s).

7. The system according to claim 6; wherein the second processing is processing for assigning a value(s) of the second variable(s) to the first variable(s).

8. A modification apparatus that modifies an unmodified program including a conditional branching statement(s) to a modified program that, based on conditional expression(s) in the conditional branching statement(s), determines whether or not to reflect a result(s) of first processing corresponding to execution processing in the conditional branching statement(s) as a processing result(s) of the execution processing.

9. A method, comprising:
modifying an unmodified program including a conditional branching statement(s) to a modified program that, based on conditional expression(s) in the conditional branching statement(s), determines whether or not to reflect a result(s) of first processing corresponding to execution processing in the conditional branching statement(s) as a processing result(s) of the execution processing; and
executing the modified program in an execution environment protected at a hardware level.

10. A non-transitory computer-readable storage medium storing a program, causing a computer to execute processing for:
receiving an unmodified program including a conditional branching statement(s); and
modifying the program including the conditional branching statement(s) to a modified program that, based on conditional expression(s) in the conditional branching statement(s), determines whether or not to reflect a result(s) of first processing corresponding to execution processing in the conditional branching statement(s) as a processing result(s) of the execution processing.

11. The modification apparatus according to claim 8; wherein the modification apparatus replaces the conditional branching statement(s) included in the unmodified program by processing including:
the first processing,
processing for performing determination based on the conditional expression(s) in the conditional branching statement(s), and
second processing for changing when a determination result(s) based on the conditional expression(s) indicates execution of the execution processing of the conditional branching statement(s), a value(s) of a variable(s) obtained as a result of the execution of the first processing to a variable(s) used in the execution processing in the conditional branching statement.

12. The modification apparatus according to claim 11; wherein the modification apparatus modifies the unmodified program such that the second processing is executed by using leakage resistance calculation.

13. The modification apparatus according to claim 11; wherein the modification apparatus generates the first processing by duplicating the execution processing in the conditional branching statement(s), replacing a first variable(s) included in the duplicated execution processing by a second variable(s) not used in the unmodified program, and initializing the second variable(s) by using the first variable(s).

14. The modification apparatus according to claim 13; wherein the second processing is processing for assigning a value(s) of the second variable(s) to the first variable(s).

15. The method according to claim 9; wherein the method replaces the conditional branching statement(s) included in the unmodified program by processing including:
the first processing,
processing for performing determination based on the conditional expression(s) in the conditional branching statement(s), and
second processing for changing when a determination result(s) based on the conditional expression(s) indicates execution of the execution processing of the conditional branching statement(s), a value(s) of a variable(s) obtained as a result of the execution of the first processing to a variable(s) used in the execution processing in the conditional branching statement.

16. The method according to claim 15; wherein the method modifies the unmodified program such that the second processing is executed by using leakage resistance calculation.

17. The method according to claim 15; wherein the method generates the first processing by duplicating the execution processing in the conditional branching statement(s), replacing a first variable(s) included in the duplicated execution processing by a second variable(s) not used in the unmodified program, and initializing the second variable(s) by using the first variable(s).

18. The method according to claim 17; wherein the second processing is processing for assigning a value(s) of the second variable(s) to the first variable(s).

19. The non-transitory computer-readable storage medium storing a program according to claim 10; wherein the computer replaces the conditional branching statement(s) included in the unmodified program by processing including:
the first processing,
processing for performing determination based on the conditional expression(s) in the conditional branching statement(s), and
second processing for changing when a determination result(s) based on the conditional expression(s) indicates execution of the execution processing of the conditional branching statement(s), a value(s) of a variable(s) obtained as a result of the execution of the first processing to a variable(s) used in the execution processing in the conditional branching statement.

20. The non-transitory computer-readable storage medium storing a program according to claim 19; wherein the computer modifies the unmodified program such that the second processing is executed by using leakage resistance calculation.

21. The non-transitory computer-readable storage medium storing a program according to claim 19; wherein the computer generates the first processing by duplicating the execution processing in the conditional branching statement(s), replacing a first variable(s) included in the duplicated execution processing by a second variable(s) not used in the unmodified program, and initializing the second variable(s) by using the first variable(s).

22. The non-transitory computer-readable storage medium storing a program according to claim 21; wherein the second processing is processing for assigning a value(s) of the second variable(s) to the first variable(s).
